(19) United States
(12) Patent Application Publication
(10) Pub. No.: US 2026/0097437 A1
(43) Pub. Date: Apr. 9, 2026

(54) STRESS-REDUCING, TORQUE TRANSMISSION DESIGN FOR MODULAR DRILLS

(71) Applicant: KENNAMETAL INC., LATROBE, PA (US)

(72) Inventor: Ruy Frota de Souza Filho, Latrobe, PA (US)

(73) Assignee: KENNAMETAL INC., LATROBE, PA (US)

(21) Appl. No.: 18/905,365

(22) Filed: Oct. 3, 2024

(51) Int. Cl. B23B 51/00

(52) U.S. Cl. CPC B23B 51/0007; B23B 2200/0423; B23B 2200/123; B23B 2205/12; B23B 2231/0268; B23B 2240/32; B23B 2250/08

(57) ABSTRACT

A cutting insert for a modular rotary cutting tool is disclosed. The cutting insert may include a shaft, opposing insert centering surfaces, and convex torque transmission insert drive surfaces.

### FIELD OF THE DISCLOSURE

The disclosure generally relates to stress-reducing, torque transmission designs for modular drills.

### BACKGROUND

Modular rotary cutting tools may rotate a cutting insert disposed in a pocket of a shank. The stress placed on the cutting insert during rotation may lead to damage to the cutting insert. This may result in the cutting insert needing to be regularly replaced which may be costly.

An improved modular rotary cutting tool is needed to reduce one or more issues associated with one or more of the current modular rotary cutting tools.

### SUMMARY

In one embodiment, a cutting insert for a modular rotary cutting tool is disclosed. The cutting insert may include a shaft, first and second opposing insert centering surfaces, and first and second convex torque transmission insert drive surfaces which are curved around an axis in a generally radial direction.

In another embodiment, a modular rotary cutting tool is disclosed. The modular rotary cutting tool may include a shank and a cutting insert. The shank may include a pocket. The pocket may include a pocket floor and first and second pocket drive walls extending at non-parallel angles from the pocket floor. The pocket floor and the first and second pocket drive walls may form the pocket. The cutting insert may be removably installed in the pocket of the shank. The cutting insert may include first and second torque transmission insert drive surfaces. The first pocket drive wall may contact the first torque transmission insert drive surface only somewhere in a middle 60% of a length of the first torque transmission insert drive surface. The second pocket drive wall may contact the second torque transmission insert drive surface only somewhere in a middle 60% of the length of the second torque transmission insert drive surface

In still another embodiment, a method of operating a modular rotary cutting tool is disclosed. In one step, a shank of the modular rotary cutting tool may be rotated. The shank may include a pocket. The pocket may include a pocket floor and first and second pocket drive walls extending at non-parallel angles from the pocket floor. The pocket floor and the first and second pocket drive walls may form the pocket. In another step, a first torque transmission insert drive surface of a cutting insert, removably installed in the pocket of the shank, may be driven with the first pocket drive wall. The first pocket drive wall may contact the first torque transmission insert drive surface only somewhere in a middle 60% of a length of the first torque transmission insert drive surface. In an additional step, a second torque transmission insert drive surface of a cutting insert, removably installed in the pocket of the shank, may be driven with the second pocket drive wall. The second pocket drive wall may contact the second torque transmission insert drive surface only somewhere in a middle 60% of the length of the second torque transmission insert drive surface.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a side perspective view of one embodiment of a cutting insert for a modular rotary cutting tool;

FIG. 2 illustrates a view along line 2-2 of the cutting insert of the embodiment of FIG. 1;

FIG. 3 illustrates a top view of the cutting insert of the embodiment of FIG. 1;

FIG. 4 illustrates a side view of the cutting insert of the embodiment of FIG. 1;

FIG. 5 illustrates another side view of the cutting insert of the embodiment of FIG. 1;

FIG. 6 illustrates a side view of the cutting insert of the embodiment of FIG. 1 further illustrating a radius of a torque transmission insert drive surface of the cutting insert;

FIG. 7 illustrates a side perspective view of one embodiment of a shank for a modular rotary cutting tool;

FIG. 8 illustrates a side view of the shank of the embodiment of FIG. 7;

FIG. 9 illustrates a top view of the shank of the embodiment of FIG. 7;

FIG. 10 illustrates a side perspective view of one embodiment of a modular rotary cutting tool with the cutting insert of the embodiment of FIG. 1 removably installed in a pocket of the shank of the embodiment of FIG. 7;

FIG. 11 illustrates a top perspective view of the modular rotary cutting tool of the embodiment of FIG. 10;

FIG. 12 illustrates a view within circle 12-12 of the modular rotary cutting tool of the embodiment of FIG. 10;

FIG. 13 illustrates a top view of the modular rotary cutting tool of the embodiment of FIG. 10;

FIG. 14 illustrates a side view of the modular rotary cutting tool of the embodiment of FIG. 10;

FIG. 15 illustrates another side view of the modular rotary cutting tool of the embodiment of FIG. 10;

FIG. 16 is a graph illustrating the variance of stress on the modular rotary cutting tool of the embodiment of FIG. 10 for varying designs;

FIG. 17 is another graph illustrating the variance of stress on the modular rotary cutting tool of the embodiment of FIG. 10 for additional varying designs; and

FIG. 18 illustrates one embodiment of a method of operating a modular rotary cutting tool.

### DETAILED DESCRIPTION

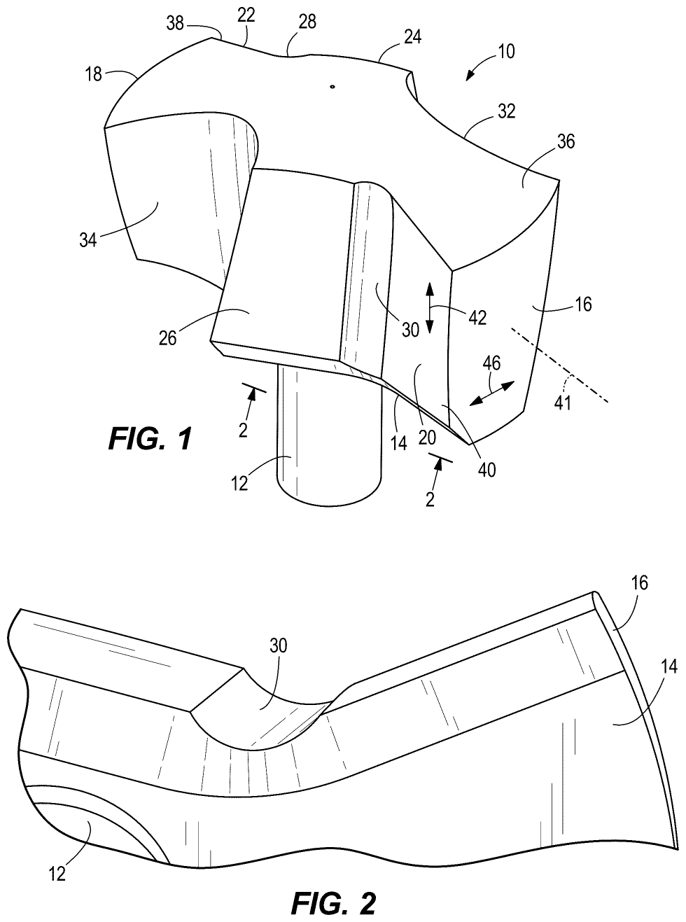

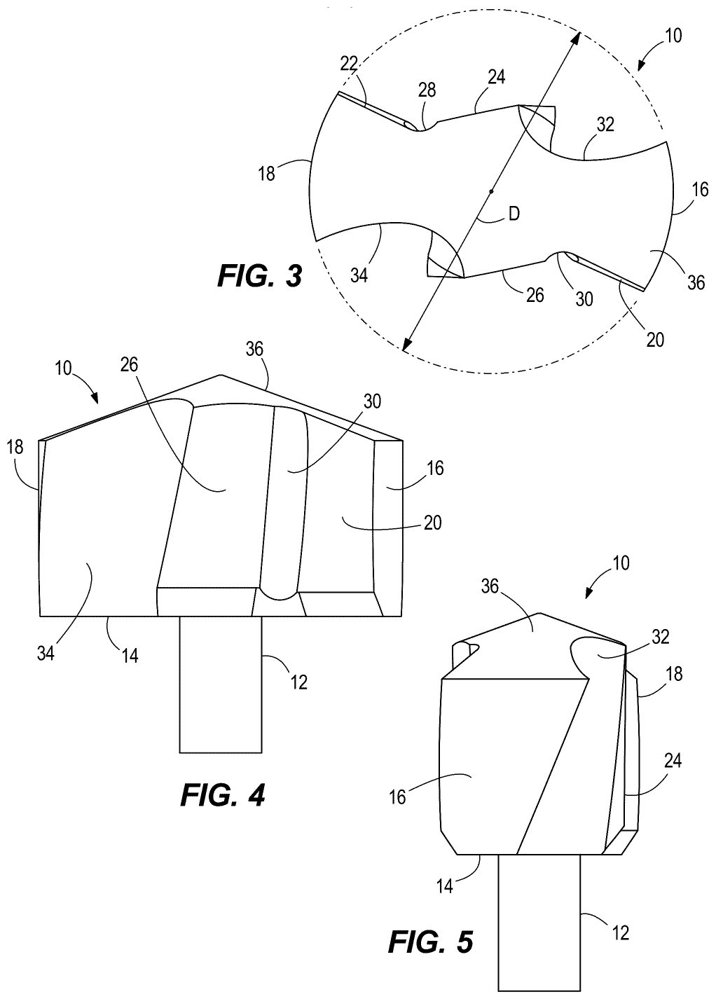

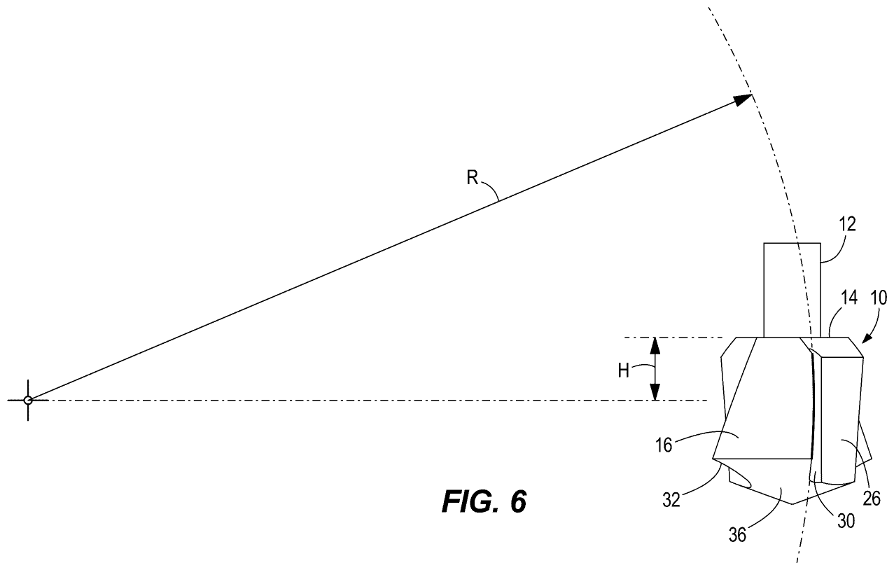

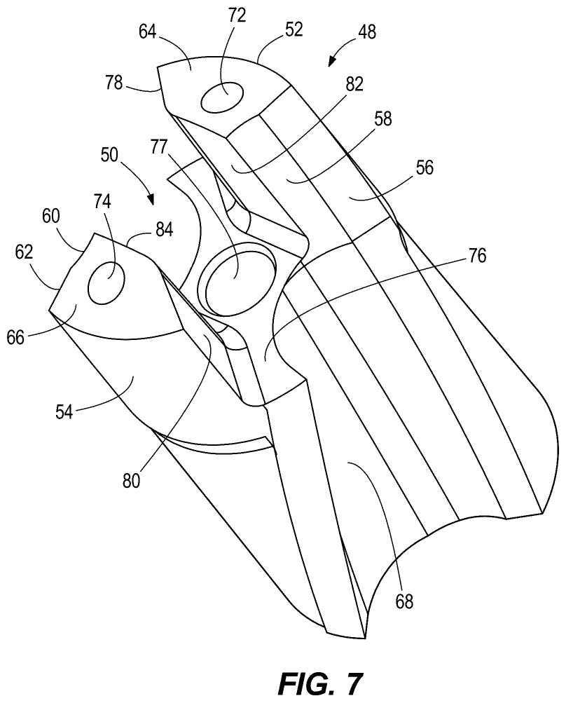

As shown in FIGS. 1-6 collectively, in one embodiment a cutting insert 10 for a modular rotary cutting tool may be disclosed. The cutting insert 10 may be made of carbide. In other embodiments, the cutting insert 10 may be made of varying materials. The cutting insert 10 may comprise a shaft 12, a bottom portion 14, outer surfaces 16 and 18, torque transmission insert drive surfaces 20 and 22, opposing insert centering surfaces 24 and 26, undercut surfaces 28 and 30, flutes 32 and 34, and top portion 36. The shaft 12 may extend downwardly from the bottom portion 14. Outer surface 16, flute 32, opposing insert centering surface 24, under surface 28, torque transmission insert drive surface 22, outer surface 18, flute 34, opposing insert centering surface 26, undercut surface 30, and torque transmission insert drive surface 20 each may be disposed in-between and adjacent to bottom portion 14 and top portion 36.

Outer surface 16 may be disposed in-between and adjacent to torque transmission insert drive surface 20 and flute 32. Flute 32 may be disposed in-between and adjacent to outer surface 16 and opposing insert centering surface 24. Opposing insert centering surface 24 may be disposed in-between and adjacent to flute 32 and undercut surface 28. Undercut surface 28 may be disposed in-between and adjacent to opposing insert centering surface 24 and torque transmission insert drive surface 22. Torque transmission insert drive surface 22 may be disposed in-between and adjacent to undercut surface 28 and outer surface 18. Outer surface 18 may be disposed in-between and adjacent to torque transmission insert drive surface 22 and flute 34. Flute 34 may be disposed in-between and adjacent to outer surface 18 and opposing insert centering surface 26. Opposing insert centering surface 26 may be disposed in-between and adjacent to flute 34 and under surface 30. Undercut surface 30 may be disposed in-between and adjacent to opposing insert centering surface 26 and torque transmission insert drive surface 20. Torque transmission insert drive surface 20 may be disposed in-between and adjacent to undercut surface 30 and outer surface 16.

Torque transmission insert surfaces 20 and 22 may be disposed on opposite sides 38 and 40 of the cutting insert 10. The cutting insert 10 may have a nominal drilling diameter D. The torque transmission surfaces 20 and 22 may be curved around an axis 41 in a generally radial direction. The torque insert transmission surfaces 20 and 22 may be convex along a longitudinal direction 42. A radius R of the convex torque transmission insert drive surfaces 20 and 22 may be in a range of one-hundred (100) millimeters to five-hundred (500) millimeters. Outer surfaces 16 and 18 may be convex along lateral direction 46. Flutes 32 and 34 may be concave along lateral direction 46. Opposing insert centering surfaces 24 and 26 may be flat/planar. Undercut surfaces 28 and 30 may be concave along lateral direction 46. Top portion 36 may comprise an angled cutting surface.

In other embodiments, the cutting insert 10 may comprise differing designs and may be made of varying materials. For instance, the shaft 12, the bottom portion 14, the outer surfaces 16 and 18, the torque transmission insert drive surfaces 20 and 22, the opposing insert centering surfaces 24 and 26, the undercut surfaces 28 and 30, the flutes 32 and 34, and the top portion 36 may comprise varying shapes, sizes, orientations, and configurations. In still other embodiments, the cutting insert 10 may be missing one or more of the above items or may comprise one or more additional surfaces.

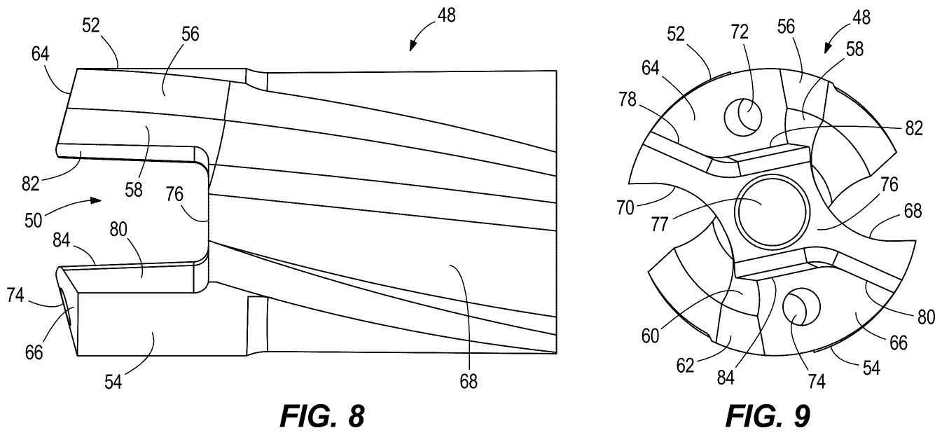

As shown in FIGS. 7-9 collectively, in one embodiment a shank 48 for a modular rotary cutting tool may be disclosed. The shank 48 may be made of steel. In other embodiments, the shank 48 may be made of varying materials. The shank 48 may comprise a pocket 50, outer walls 52 and 54, inner walls 56, 58, 60, and 62, top walls 64 and 66, shank flutes 68 and 70, and coolant passages 72 and 74. The pocket 50 may comprise a pocket floor 76, a bore 77, pocket drive walls 78 and 80, and opposing centering walls 82 and 84. The pocket drive walls 78 and 80, and opposing centering walls 82 and 84 may extend at non-parallel angles from the pocket floor 76. The bore 77 may be disposed in the pocket floor 76. The pocket floor 76, pocket drive walls 78 and 80, opposing centering walls 82 and 84, inner walls 56, 58, 60, and 62, and top walls 64 and 66 may be flat/planar. The outer walls 52 and 54 may be convex.

The outer wall 52 may be disposed in-between and adjacent to the inner wall 56 and the pocket drive wall 78. The pocket drive wall 78 may be disposed in-between and adjacent to the outer wall 52 and the opposing centering wall 82. The opposing centering wall 82 may be disposed in-between and adjacent to the pocket drive wall 78 and the inner wall 58. The inner wall 58 may be disposed in-between and adjacent to the opposing centering wall 82 and the inner wall 56. The inner wall 56 may be disposed in-between and adjacent to the inner wall 58 and the outer wall 52. The coolant passage 72 may be disposed in the top wall 64. The top wall 64 may be disposed at non-parallel angles to and at the top of the outer surface 52, pocket drive wall 78, opposing centering wall 82, and inner walls 56 and 58.

The outer wall 54 may be disposed in-between and adjacent to the inner wall 62 and the pocket drive wall 80. The pocket drive wall 80 may be disposed in-between and adjacent to the outer wall 54 and the opposing centering wall 84. The opposing centering wall 84 may be disposed in-between and adjacent to the pocket drive wall 80 and the inner wall 60. The inner wall 60 may be disposed in-between and adjacent to the opposing centering wall 84 and the inner wall 62. The inner wall 62 may be disposed in-between and adjacent to the inner wall 60 and the outer wall 54. The coolant passage 74 may be disposed in the top wall 66. The shank flutes 68 and 70 may be disposed on opposite sides 86 and 88 of the pocket 50 adjacent the pocket floor 76. The top wall 66 may be disposed at non-parallel angles to and at the top of the outer surface 54, pocket drive wall 80, opposing centering wall 84, and inner walls 60 and 62.

In other embodiments, the shank 48 may comprise differing designs and may be made of varying materials. For instance, the pocket 50, the outer walls 52 and 54, the inner walls 56, 58, 60, and 62, the top walls 64 and 66, the shank flutes 68 and 70, and the coolant passages 72 and 74 may comprise varying shapes, sizes, orientations, and configurations. In still other embodiments, the shank 48 may be missing one or more of the above items or may comprise one or more additional surfaces.

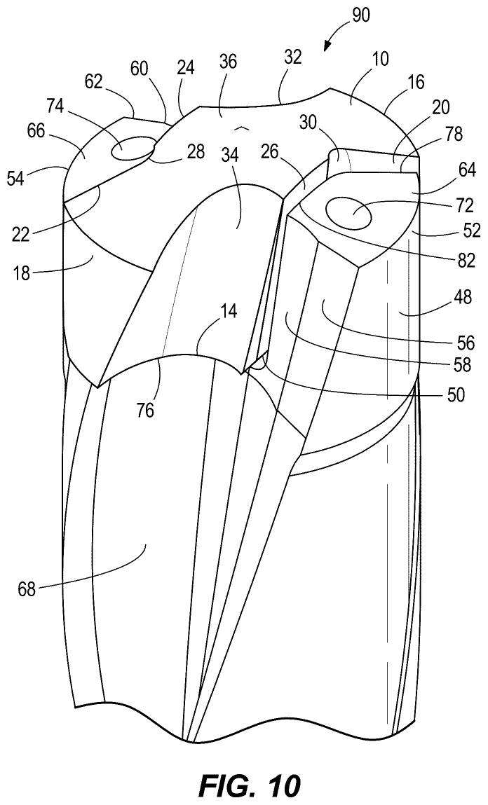

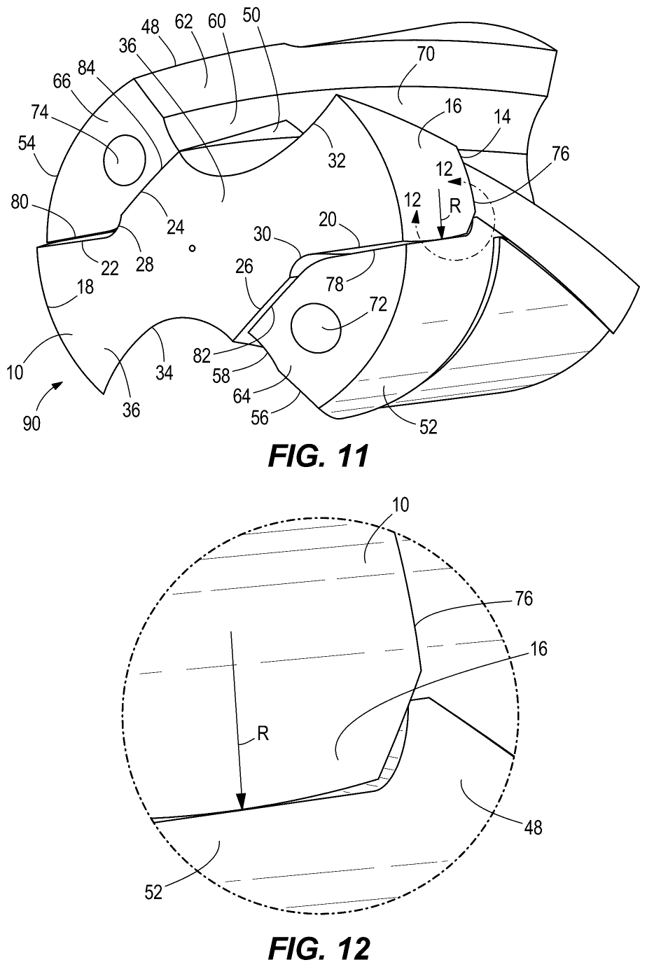

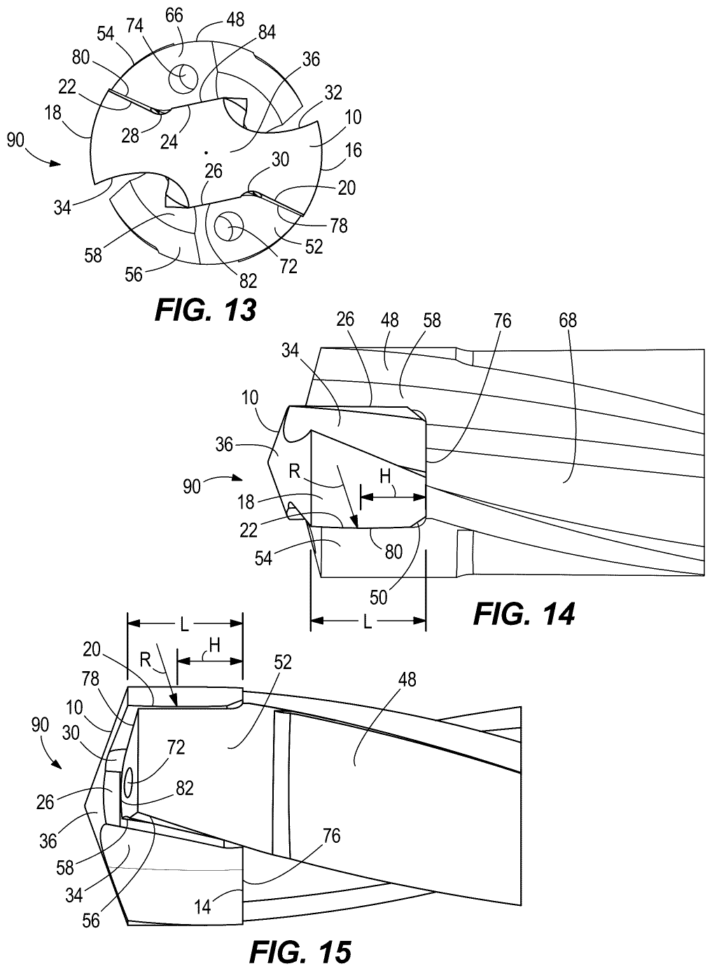

As shown in FIGS. 10-15 collectively, in one embodiment a modular rotary cutting tool 90 may comprise the cutting insert 10 of the embodiment of FIGS. 1-7 removably installed in the pocket 50 of the shank 48 of the embodiment of FIGS. 7-9 with an interference fit. The shaft 12 of the cutting insert 10 may be removably attached in the bore 77 of the pocket floor 76. The bottom portion 14 of the cutting insert 10 may be disposed against the pocket floor 76 of the pocket 50 of the shank 48. The opposing insert centering surface 26 of the cutting insert 10 may be disposed against the opposing centering wall 82 of the shank 48. The opposing insert centering wall 82 may be flat/planar. The opposing insert centering surface 24 of the cutting insert 10 may be disposed against the opposing centering wall 84 of the shank 48. The opposing insert centering wall 84 may be flat/planar.

The torque transmission insert drive surface 20 of the cutting insert 10 may be disposed against the pocket drive wall 78 of the shank 48. The torque transmission insert drive surface 20 of the cutting insert 10 may be convex and the pocket drive wall 78 of the shank 48 may be flat/planar or have a radius substantially larger than that of the torque transmission insert drive surface 20 of the cutting insert 10. The nominal drilling diameter D of the cutting insert 10 may be in a range of ten (10) millimeters to forty (40) millimeters. The torque transmission insert drive surface 20 of the cutting insert 10 may have a radius R in a range of one-hundred (100) millimeters to five-hundred (500) millimeters. The pocket drive wall 78 of the shank 48 may only contact the torque transmission insert drive surface 20 at a height H of the torque transmission insert drive surface 20 in a range of three (3.00) millimeters to ten (10.00) millimeters. In another embodiment, the pocket drive wall 78 of the shank 48 may only contact the torque transmission insert drive surface 20 somewhere in a middle 60% of a length L of the torque transmission insert drive surface 20. The pocket drive wall 78 of the shank 48 may contact the torque transmission inert drive surface 20 anywhere along the middle 60% of the length L of the torque transmission insert drive surface 20. A ratio of the height H of the torque transmission insert drive surface 20 of the cutting insert 10 to the nominal drilling diameter D of the cutting insert 10 (H/D) may be in a range of 0.075 to 1.0, and may have a preferred range of 0.18 to 0.32. A ratio of the radius R of the torque transmission insert drive surface 20 of the cutting insert 10 to the nominal drilling diameter D of the cutting insert 10 (R/D) may be in a range of 2.5 to 50, and may have a preferred range of 6 to 20. The flute 34 of the cutting insert 10 may be aligned with and adjacent to the shank flute 68 of the shank 48.

The torque transmission insert drive surface 22 of the cutting insert 10 may be disposed against the pocket drive wall 80 of the shank 48. The torque transmission insert drive surface 22 may be convex and the pocket drive wall 80 of the shank 48 may be flat/planar or have a radius substantially larger than that of the torque transmission insert drive surface 22 of the cutting insert 10. The torque transmission insert drive surface 22 of the cutting insert 10 may have the radius R in a range of one-hundred (100) millimeters to five-hundred (500) millimeters. The pocket drive wall 80 of the shank 48 may only contact the torque transmission insert drive surface 22 at the height H of the torque transmission insert drive surface 22 in the range of three (3.00) millimeters to ten (10.00) millimeters. In another embodiment, the pocket drive wall 80 of the shank 48 may only contact the torque transmission insert drive surface 22 somewhere in a middle 60% of the length L of the torque transmission insert drive surface 22. The pocket drive wall 80 of the shank 48 may contact the torque transmission inert drive surface 22 anywhere along the middle 60% of the length L of the torque transmission insert drive surface 22. A ratio of the height H of the torque transmission insert drive surface 22 of the cutting insert 10 to the nominal drilling diameter D of the cutting insert 10 (H/D) may be in a range of 0.075 to 1.0, and may have a preferred range of 0.18 to 0.32. A ratio of the radius R of the torque transmission insert drive surface 22 of the cutting insert 10 to the nominal drilling diameter D of the cutting insert 10 (R/D) may be in a range of 2.5 to 50, and may have a preferred range of 6 to 20. The flute 32 of the cutting insert 10 may be aligned with and adjacent to the shank flute 70 of the shank 48.

In other embodiments, the cutting insert 10 of the modular rotary cutting tool 90 may comprise differing designs and may be made of varying materials. For instance, the shaft 12, the bottom portion 14, the outer surfaces 16 and 18, the torque transmission insert drive surfaces 20 and 22, the opposing insert centering surfaces 24 and 26, the undercut surfaces 28 and 30, the flutes 32 and 34, and the top portion 36 may comprise varying shapes, sizes, orientations, and configurations. In still other embodiments, the cutting insert 10 of the modular rotary cutting tool 90 may be missing one or more of the above items or may comprise one or more additional surfaces.

In other embodiments, the shank 48 of the modular rotary cutting tool 90 may comprise differing designs and may be made of varying materials. For instance, the pocket 50, the outer walls 52 and 54, the inner walls 56, 58, 60, and 62, the top walls 64 and 66, the shank flutes 68 and 70, and the coolant passages 72 and 74 may comprise varying shapes, sizes, orientations, and configurations. In still other embodiments, the shank 48 of the modular rotary cutting tool 90 may be missing one or more of the above items or may comprise one or more additional surfaces.

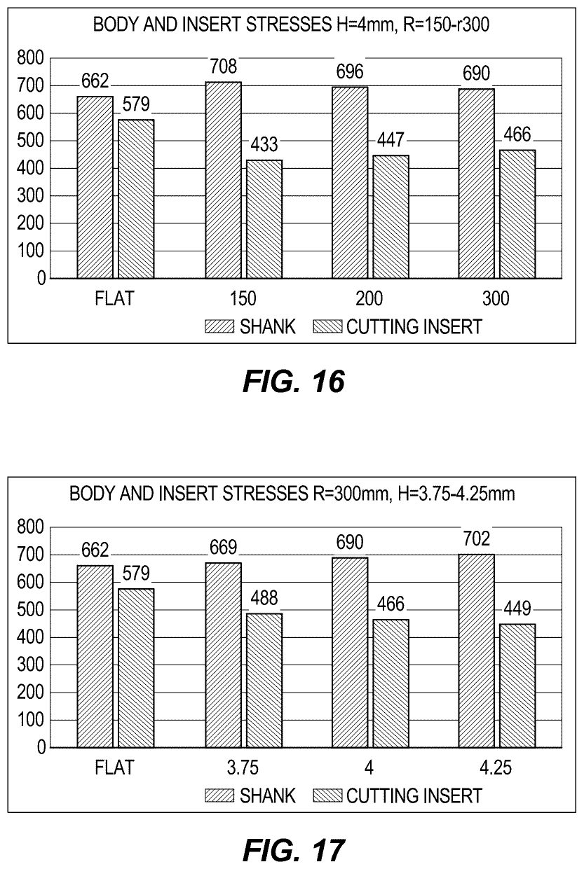

The graph of FIG. 16 illustrates the variance in stress on the shank 48 and the cutting insert 10 of the modular rotary cutting tool 90 of FIGS. 10-15 when the radius R of the convex torque transmission insert drive surfaces 20 and 22 ranges between one-hundred-fifty (150) millimeters to three-hundred (300) millimeters while keeping the height H at which, respectively, the pocket drive walls 78 and 80 of the shank 48 contact the torque transmission insert drive surfaces 20 and 22, at a constant of four (4) millimeters. For comparison, the graph also shows a ‘flat’ embodiment at which the height H is zero (0) at which, respectively, the pocket drive walls 78 and 80 of the shank 48 contact the torque transmission insert drive surfaces 20 and 22 due to the torque transmission insert drive surfaces 20 and 22 being flat with a radius R of zero (0). The graph illustrates that increasing the radius R of the convex torque transmission insert drive surfaces 20 and 22 while keeping the height H at which, respectively, the pocket drive walls 78 and 80 of the shank 48 contact the torque transmission insert drive surfaces 20 and 22, may increase the stress on the shank 48 relative to the stress on the shank 48 when flat torque transmission insert drive surfaces 20 and 22 are used. The graph further illustrates that increasing the radius R of the convex torque transmission insert drive surfaces 20 and 22 while keeping the height H at which, respectively, the pocket drive walls 78 and 80 of the shank 48 contact the torque transmission insert drive surfaces 20 and 22, may reduce the stress on the cutting insert 10 relative to the stress on the cutting insert 10 when flat torque transmission insert drive surfaces 20 and 22 are used. The shank 48 may be more adept at handling the stress than the cutting insert 10. As a result, this design change may improve the longevity and durability of the cutting insert 10 which may reduce how often the cutting insert 10 may need to be replaced. This design change may save substantial cost.

The graph of FIG. 17 illustrates the variance in stress on the shank 48 and the cutting insert 10 of the modular rotary cutting tool 90 of FIGS. 10-15 when the height H at which, respectively, the pocket drive walls 78 and 80 of the shank 48 contact the torque transmission insert drive surfaces 20 and 22 range between three-and-three-quarter (3.75) millimeters and four-and-one-quarter (4.25) millimeters while keeping the radius R of the convex torque transmission insert drive surfaces 20 and 22 at a constant of three-hundred (300) millimeters. For comparison, the graph also shows a ‘flat’ embodiment at which the height H at which, respectively, the pocket drive walls 78 and 80 of the shank 48 contact the torque transmission insert drive surfaces 20 and 22, is zero (0) due to the torque transmission insert drive surfaces 20 and 22 being flat with a radius R of zero (0). The graph illustrates that increasing the height H at which, respectively, the pocket drive walls 78 and 80 of the shank 48 contact the torque transmission insert drive surfaces 20 and 22, while keeping the radius R constant may increase the stress on the shank 48 while decreasing the stress on the cutting insert 10. The shank 48 may be more adept at handling the stress than the cutting insert 10. As a result, this design change may improve the longevity and durability of the cutting insert 10 which may reduce how often the cutting insert 10 may need to be replaced. This design change may save substantial cost.

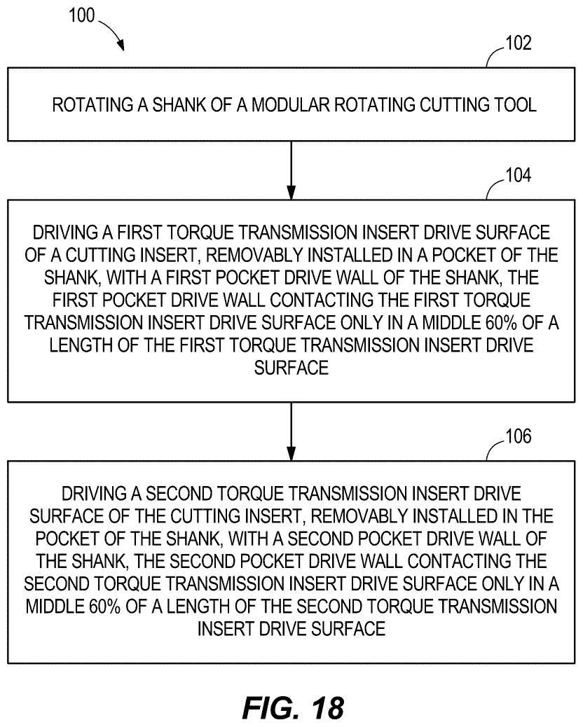

FIG. 18 illustrates one embodiment of a method 100 of operating a modular rotary cutting tool. The method 100 may utilize any of the cutting insert 10, shank 48, and modular rotating cutting tool 90 embodiments of FIGS. 1-15. In other embodiments, the method 100 may utilize varying cutting insert, shank, and modular rotating cutting tool embodiments.

Step 102 may comprise rotating a shank of the modular rotary cutting tool. The shank may comprise a pocket. The pocket may comprise a pocket floor and first and second pocket drive walls extending at non-parallel angles from the pocket floor. The pocket floor and the first and second pocket drive walls may form the pocket.

Step 104 may comprise driving a first torque transmission insert drive surface of a cutting insert, removably installed in the pocket of the shank, with the first pocket drive wall. The first pocket drive wall may contact the first torque transmission insert drive surface only somewhere in a middle 60% of a length of the first torque transmission insert drive surface. The first pocket drive wall may contact the first torque transmission inert drive surface anywhere along the middle 60% of the length of the first torque transmission insert drive surface.

Step 106 may comprise driving a second torque transmission insert drive surface of a cutting insert, removably installed in the pocket of the shank, with the second pocket drive wall. The second pocket drive wall may contact the second torque transmission insert drive surface only somewhere in a middle 60% of the length of the second torque transmission insert drive surface. The second pocket drive wall may contact the second torque transmission inert drive surface anywhere along the middle 60% of the length of the second torque transmission insert drive surface.

In one embodiment of the method 100 of FIG. 18, the first pocket drive wall of the shank may only contact the first torque transmission insert drive surface at a height of the first torque transmission insert drive surface in a range of three (3.00) millimeters to ten (10.00) millimeters. Similarly, the second pocket drive wall of the shank may only contact the second torque transmission insert drive surface at the height of the second torque transmission insert drive surface in the range of three (3.00) millimeters to ten (10.00) millimeters.

In another embodiment of the method 100 of FIG. 18, the first and second torque transmission insert drive surfaces may be convex.

In still another embodiment of the method 100 of FIG. 18, the first and second torque transmission insert drive surfaces may each have a radius of in a range of one-hundred (100) millimeters to five-hundred (500) millimeters.

In yet another embodiment of the method 100 of FIG. 18, the shank may further comprise first and second opposing centering walls, and the cutting insert may further comprise first and second opposing insert centering surfaces. The first opposing centering wall of the shank may be disposed against the first opposing insert centering surface of the cutting insert, and the second opposing centering wall of the shank may be disposed against the second opposing insert centering surface of the cutting insert.

In still another embodiment of the method 100 of FIG. 18, the cutting insert may further comprise first and second undercuts surfaces. The first undercut surface may be disposed between the first torque transmission insert drive surface and the first opposing insert centering surface. The second undercut surface may be disposed between the second torque transmission insert drive surface and the second opposing insert centering surface.

In yet another embodiment of the method 100 of FIG. 18, the cutting insert may further comprise first and second flutes. The first flute may be disposed adjacent to the first opposing insert centering surface, and the second flute may be disposed adjacent to the second opposing insert centering surface. The shank may further comprise first and second shank flutes. The first flute of the cutting insert may be aligned with the first shank flute of the shank, and the second flute of the cutting insert may be aligned with the second shank flute of the shank.

In still another embodiment of the method 100 of FIG. 18, the cutting insert may further comprise first and second outer surfaces. The first outer surface may be disposed adjacent the second flute. The first outer surface may also be disposed adjacent the first torque transmission insert drive surface. The second outer surface may be disposed adjacent the first flute. The second outer surface may also be disposed adjacent the second torque transmission insert drive surface.

In an additional embodiment of the method 100 of FIG. 18, the cutting insert may further comprise first and second undercuts surfaces. The first undercut surface may be disposed between the first torque transmission insert drive surface and the first opposing insert centering surface. The second undercut surface may be disposed between the second torque transmission insert drive surface and the second opposing insert centering surface.

In other embodiments one or more steps of the method 100 of FIG. 18 may vary in substance or in order, one or mores steps of the method 100 may not be followed, or one or more additional steps may be added. In still other embodiments, the method 100 of FIG. 18 may further vary.

One or more embodiments of the disclosure may reduce one or more of the issues associated with one or more of the existing modular rotary cutting tools. For instance, using one or more of the embodiments of the modular rotary cutting tools disclosed herein may result in reduced stress placed on the cutting insert of the modular rotary cutting tool. This may result in the cutting insert needing to be replaced less frequently which may save significant cost.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A cutting insert for a modular rotary cutting tool comprising:
a shaft;
first and second opposing insert centering surfaces; and
first and second convex torque transmission insert drive surfaces which are curved around an axis in a generally radial direction.

2. The cutting insert of claim 1 wherein the first and second convex torque transmission insert drive surfaces are on opposite sides of the cutting insert.

3. The cutting insert of claim 1 wherein a radius of the first and second convex torque transmission insert drive surfaces is in a range of one-hundred (100) millimeters to five-hundred (500) millimeters.

4. The cutting insert of claim 1 wherein a ratio of a radius of the first and second convex torque transmission insert drive surfaces to a nominal drilling diameter of the cutting insert is in a range of 2.5 to 50.

5. The cutting insert of claim 1 further comprising first and second undercuts surfaces, wherein the first undercut surface is disposed between the first convex torque transmission insert drive surface and the first opposing insert centering surface, and the second undercut surface is disposed between the second convex torque transmission insert drive surface and the second opposing insert centering surface.

6. The cutting insert of claim 1 further comprising first and second flutes, wherein the first flute is disposed adjacent to the first opposing insert centering surface, and the second flute is disposed adjacent to the second opposing insert centering surface.

7. The cutting insert of claim 6 further comprising first and second outer surfaces, wherein the first outer surface is disposed adjacent the second flute, the first outer surface is disposed adjacent the first convex torque transmission insert drive surface, the second outer surface is disposed adjacent the first flute, and the second outer surface is disposed adjacent the second convex torque transmission insert drive surface.

8. The cutting insert of claim 7 further comprising first and second undercuts surfaces, wherein the first undercut surface is disposed between the first convex torque transmission insert drive surface and the first opposing insert centering surface, and the second undercut surface is disposed between the second convex torque transmission insert drive surface and the second opposing insert centering surface.

9. A modular rotary cutting tool comprising:
a shank comprising a pocket, the pocket comprising:
a pocket floor;
first and second pocket drive walls extending at non-parallel angles from the pocket floor, wherein the pocket floor, and the first and second pocket drive walls form the pocket; and
a cutting insert removably installed in the pocket of the shank, the cutting insert comprising:
first and second torque transmission insert drive surfaces;
wherein the first pocket drive wall contacts the first torque transmission insert drive surface only somewhere in a middle 60% of a length of the first torque transmission insert drive surface, and the second pocket drive wall contacts the second torque transmission insert drive surface only somewhere in a middle 60% of the length of the second torque transmission insert drive surface.

10. The modular rotary cutting tool of claim 9 wherein the first pocket drive wall of the shank only contacts the first torque transmission insert drive surface at a height of the first torque transmission insert drive surface in a range of three (3.00) millimeters to ten (10.00) millimeters, and the second pocket drive wall of the shank only contacts the second torque transmission insert drive surface at the height of the second torque transmission insert drive surface in the range of three (3.00) millimeters to ten (10.00) millimeters.

11. The modular rotary cutting tool of claim 9 wherein the first pocket drive wall of the shank only contacts the first torque transmission insert drive surface at a height of the first torque transmission insert drive surface, and the second pocket drive wall of the shank only contacts the second torque transmission insert drive surface at the height of the second torque transmission insert drive surface, wherein a ratio of the height of the first torque transmission insert drive surface and the height of the second torque transmission insert drive surface to a nominal drilling diameter of the cutting insert is in a range of 0.075 to 1.0.

12. The modular rotary cutting tool of claim 10 wherein the first and second torque transmission insert drive surfaces are convex.

13. The modular rotary cutting tool of claim 12 wherein the first and second torque transmission insert drive surfaces each have a radius in a range of one-hundred (100) millimeters to five-hundred (500) millimeters.

14. The modular rotary cutting tool of claim 12 wherein a ratio of a radius of the first and second torque transmission insert drive surfaces to a nominal drilling diameter of the cutting insert is in a range of 2.5 to 50.

15. The modular rotary cutting tool of claim 11 wherein the shank further comprises first and second opposing centering walls, and the cutting insert further comprises first and second opposing insert centering surfaces, wherein the first opposing centering wall of the shank is disposed against the first opposing insert centering surface of the cutting insert, and the second opposing centering wall of the shank is disposed against the second opposing insert centering surface of the cutting insert.

16. The modular rotary cutting tool of claim 15 wherein the cutting insert further comprises first and second undercuts surfaces, wherein the first undercut surface is disposed between the first torque transmission insert drive surface and the first opposing insert centering surface, and the second undercut surface is disposed between the second torque transmission insert drive surface and the second opposing insert centering surface.

17. The modular rotary cutting tool of claim 15 wherein the cutting insert further comprises first and second flutes, wherein the first flute is disposed adjacent to the first opposing insert centering surface, and the second flute is disposed adjacent to the second opposing insert centering surface, and the shank further comprises first and second shank flutes, wherein the first flute of the cutting insert is aligned with the first shank flute of the shank, and the second flute of the cutting insert is aligned with the second shank flute of the shank.

18. The modular rotary cutting tool of claim 17 wherein the cutting insert further comprises first and second outer surfaces, wherein the first outer surface is disposed adjacent the second flute, the first outer surface is disposed adjacent the first torque transmission insert drive surface, the second outer surface is disposed adjacent the first flute, and the second outer surface is disposed adjacent the second torque transmission insert drive surface.

19. The modular rotary cutting tool of claim 18 wherein the cutting insert further comprises first and second undercuts surfaces, wherein the first undercut surface is disposed between the first torque transmission insert drive surface and the first opposing insert centering surface, and the second undercut surface is disposed between the second torque transmission insert drive surface and the second opposing insert centering surface.

20. A method of operating a modular rotary cutting tool comprising:
rotating a shank of the modular rotary cutting tool, the shank comprising a pocket comprising a pocket floor and first and second pocket drive walls extending at non-parallel angles from the pocket floor, wherein the pocket floor, and the first and second pocket drive walls form the pocket;
driving a first torque transmission insert drive surface of a cutting insert, removably installed in the pocket of the shank, with the first pocket drive wall, wherein the first pocket drive wall contacts the first torque transmission insert drive surface only somewhere in a middle 60% of a length of the first torque transmission insert drive surface; and
driving a second torque transmission insert drive surface of a cutting insert, removably installed in the pocket of the shank, with the second pocket drive wall, wherein the second pocket drive wall contacts the second torque transmission insert drive surface only somewhere in a middle 60% of the length of the second torque transmission insert drive surface.

21. The method of claim 20 wherein the first pocket drive wall of the shank only contacts the first torque transmission insert drive surface at a height of the first torque transmission insert drive surface in a range of three (3.00) millimeters to ten (10.00) millimeters, and the second pocket drive wall of the shank only contacts the second torque transmission insert drive surface at the height of the second torque transmission insert drive surface in the range of three (3.00) millimeters to ten (10.00) millimeters.

22. The method of claim 20 wherein the first pocket drive wall of the shank only contacts the first torque transmission insert drive surface at a height of the first torque transmission insert drive surface, and the second pocket drive wall of the shank only contacts the second torque transmission insert drive surface at the height of the second torque transmission insert drive surface, wherein a ratio of the height of the first torque transmission insert drive surface and the height of the second torque transmission insert drive surface to a nominal drilling diameter of the cutting insert is in a range of 0.075 to 1.0.

23. The method of claim 21 wherein the first and second torque transmission insert drive surfaces are convex.

24. The method of claim 23 wherein the first and second torque transmission insert drive surfaces each have a radius of in a range of one-hundred (100) millimeters to five-hundred (500) millimeters.

25. The method of claim 23 wherein a ratio of a radius of the first and second torque transmission insert drive surfaces to a nominal drilling diameter of the cutting insert is in a range of 2.5 to 50.

26. The method of claim 22 wherein the shank further comprises first and second opposing centering walls, and the cutting insert further comprises first and second opposing insert centering surfaces, wherein the first opposing centering wall of the shank is disposed against the first opposing insert centering surface of the cutting insert, and the second opposing centering wall of the shank is disposed against the second opposing insert centering surface of the cutting insert.

27. The method of claim 26 wherein the cutting insert further comprises first and second undercuts surfaces, wherein the first undercut surface is disposed between the first torque transmission insert drive surface and the first opposing insert centering surface, and the second undercut surface is disposed between the second torque transmission insert drive surface and the second opposing insert centering surface.

28. The method of claim 26 wherein the cutting insert further comprises first and second flutes, wherein the first flute is disposed adjacent to the first opposing insert centering surface, and the second flute is disposed adjacent to the second opposing insert centering surface, and the shank further comprises first and second shank flutes, wherein the first flute of the cutting insert is aligned with the first shank flute of the shank, and the second flute of the cutting insert is aligned with the second shank flute of the shank.

29. The method of claim 28 wherein the cutting insert further comprises first and second outer surfaces, wherein the first outer surface is disposed adjacent the second flute, the first outer surface is disposed adjacent the first torque transmission insert drive surface, the second outer surface is disposed adjacent the first flute, and the second outer surface is disposed adjacent the second torque transmission insert drive surface.

30. The method of claim 29 wherein the cutting insert further comprises first and second undercuts surfaces, wherein the first undercut surface is disposed between the first torque transmission insert drive surface and the first opposing insert centering surface, and the second undercut surface is disposed between the second torque transmission insert drive surface and the second opposing insert centering surface.
